(19) United States
(12) Patent Application Publication
(10) Pub. No.: US 2023/0382771 A1
(43) Pub. Date: Nov. 30, 2023

(54) COMPOSITIONS COMPRISING CYCLODEXTRIN FOR TREATMENT OF WASTE

(71) Applicant: PPG Industries Ohio, Inc., Cleveland, OH (US)

(72) Inventor: Howard Lewis Senkfor, South Euclid, OH (US)

(73) Assignee: PPG Industries Ohio, Inc., Cleveland, OH (US)

(21) Appl. No.: 18/249,755

(22) PCT Filed: Oct. 8, 2021
(86) PCT No.: PCT/US2021/054134

§ 371 Date: Apr. 20, 2023

Related U.S. Application Data
(60) Provisional application No. 63/107,471, filed on Oct. 30, 2020.

(51) Int. Cl. C02F 1/56; C09D 7/00

(52) U.S. Cl. CPC C02F 1/56; C09D 7/71; C02F 2101/308

(57) ABSTRACT

The present invention is directed towards compositions, systems, and methods for treating contaminants from wastewater streams using cyclodextrin and/or a cyclodextrin derivative. Also disclosed herein is the use of a cyclodextrin, a cyclodextrin derivative, or a combination thereof as a detackifying and/or flocculating agent.

### FIELD OF THE INVENTION

The present invention relates to compositions useful in waste treatment and removal processes. More particularly, the present invention relates to compositions for detackifying and flocculating paint, which compositions are useful in water-based and solvent-based paint denaturant systems.

### BACKGROUND INFORMATION

Contaminants, such as waste, are collected in water streams for removal in a variety of industries. These contaminants include, for example, chemicals and solid waste such as paints, sewage, animal by-products (fat, flesh, blood), metals, salts, pesticides, or biological or microbial contaminants, among other materials. Many of these contaminants are difficult to remove from wastewater because they have poor or very good solubility, are sticky and/or tacky, or can react with other contaminants present in the wastewater stream.

An example of such wastewater stream is used in paint spray booths. Automatic spraying techniques have long been employed for painting large articles such as cars, trucks, refrigerators, etc. The items being sprayed are generally advanced along a conveyor line which passes through a fine spray of paint directed at the articles being painted from spray guns which are typically located at the sides of the conveyor. Overspray paint, that is, paint which does not contact the article being painted, forms a fine mist of paint in the air space surrounding the painted article. This paint mist must be removed from the air. To accomplish this, the contaminated air is pulled through the paint spray booth by air exhaust fans. A curtain of recirculating water is maintained across the path of the air in a manner such that the air must pass through the water curtain to reach the exhaust fans. As the air passes through the water curtain, the paint mist is “scrubbed” from the air and carried to a sump basin (i.e., “pit”) usually located below the paint spray booth. In this area, the paint particles are separated from the water so that the water may be recycled, reused, and the paint particles disposed of.

The term “paint” as used herein is intended to encompass a mixture of resin, pigment, and a suitable liquid vehicle that is reasonably fluid and provides a thin and adherent coating when applied to a substrate. As such, the term “paint” is intended to encompass all paints, lacquers, varnishes, basecoats, clearcoats, primers, solvent-based, water-based, solvent-free, and the like. Paint is a tacky material and it tends to coagulate and adhere to the spray booth surfaces, ductwork, piping, particularly in the sump and drain areas, piping and walls, and must constantly be removed from the sump system to prevent clogging of the sump drain and recirculating system. In order assist in the removal of the oversprayed paint from the air and to provide efficient operation of paint spray booths, detackifying agents are commonly employed in the water used in such systems, and are typically incorporated into the water wash recirculated in the paint spray system. Detackifying the paint eliminates or minimizes the adhesive properties, or tackiness, of the paint, thereby preventing the oversprayed paint from adhering to the surfaces of the spray booth, such as the walls, piping, pumps, pit, return line, and any other areas and/or parts of the recirculation system.

One of the difficulties with recovering paint overspray in a water wash spray booth as described above is the limited amount of paint which can be incorporated into the water. As such, detackifying agents should have a high load capacity, such that the water wash recirculated through the spray booth can quickly detackify, coagulate and flocculate a high volume of oversprayed paint before exhaustion and to facilitate removal of the contaminant, if desired.

Moreover, in recent years, the need to reduce solvent emission has resulted in the reduction of solvent-based or solventborne paints, and an increase in the use of water-based or waterborne paints. The organic content in solvent-based paints, however, requires the use of different detackifying processes in paint spray booths. This is problematic where multiple paint spray booths using different paint compositions are connected to the same pit. In such situations, the pit must be capable detackifying multiple types of paints (e.g., waterborne and solventborne, as well as 1K and 2K paint systems).

Accordingly, a detackifying agent and compositions comprising the same which are useful for treating contaminants in wastewater, such as treating both water-based and solvent-based paints, is desired.

### SUMMARY OF THE INVENTION

Disclosed herein is a method for treating and/or removing contaminants from water, comprising the step of contacting the contaminants with a cyclodextrin, a cyclodextrin derivative, or a combination thereof in an aqueous medium.

Also disclosed herein is a method for treating and/or removing contaminants from water, comprising contacting the contaminants with an aqueous medium to form a contaminated aqueous medium, and adding cyclodextrin, a cyclodextrin derivative, or a combination thereof to the contaminated aqueous medium.

Further disclosed herein is a recirculating water system comprising an aqueous medium comprising a cyclodextrin, a cyclodextrin derivative, or a combination thereof.

Still further disclosed herein is a method of treating oversprayed paint particles in a paint spray booth including the recirculating water system comprising an aqueous medium comprising a cyclodextrin, a cyclodextrin derivative, or a combination thereof, the method comprising contacting the oversprayed paint particles with the aqueous medium recirculating through the recirculating water system.

Also disclosed herein is a method for preparing a recirculating water system for treating oversprayed paint in a paint spray booth, the method comprising adding an additive composition comprising a cyclodextrin, a cyclodextrin derivative, or a combination thereof to the recirculating water system.

Further disclosed herein is a method for maintaining a recirculating water system for treating oversprayed paint in a paint spray booth, the method comprising adding an additive composition comprising a cyclodextrin, a cyclodextrin derivative, or a combination thereof to the recirculating water system.

Still further disclosed herein is an additive composition for addition to a water for treating contaminants in a wastewater stream, the addition composition comprising cyclodextrin, a cyclodextrin derivative, or any combination thereof.

Also disclosed herein is the use of a cyclodextrin, a cyclodextrin derivative, or a combination thereof as a detackifying and/or flocculating agent.

### DETAILED DESCRIPTION OF THE INVENTION

The present invention is directed to compositions, systems, and methods for treating contaminants from wastewater streams using cyclodextrin and/or a cyclodextrin derivative.

The present invention is directed to a method for treating and/or removing contaminants from water, comprising the step of contacting the contaminants with a cyclodextrin, a cyclodextrin derivative, or a combination thereof in an aqueous medium.

In addition, the present invention is also directed to a method for treating and/or removing contaminants from water, comprising contacting the contaminants with an aqueous medium to form a contaminated aqueous medium, and adding cyclodextrin, a cyclodextrin derivative, or a combination thereof to the contaminated aqueous medium.

As used herein, the term “treating” with respect to a contaminant means that the cyclodextrin and/or cyclodextrin derivative prevent the contaminant from fouling and/or contaminating surfaces that come into contact with the wastewater stream and/or enable removal of contaminants. For example, the cyclodextrin and/or cyclodextrin derivative may be a detackifying agent for contaminants in a waste stream, such as, for example, paint collected in a water recirculator system for a paint spray booth, and the detackifying agent treats the paint particles and prevents them from contaminating other surfaces and the optional facilitation of removal of paint and/or other contaminants. As used herein, the term “paint particles” refers to uncured paint particles or droplets of an uncured paint composition. The paint particles may be particles or droplets or a paint mist (e.g., oversprayed paint particles) that is emulsified in water or aqueous medium.

The cyclodextrin may be added to water as an additive composition to form a composition comprising cyclodextrin and/or a cyclodextrin derivative. Accordingly, the present invention is directed to additive compositions for addition to water for treating contaminants in a wastewater stream. For example, the present invention is directed to additive compositions for additions to a recirculating water system for treating paint overspray particles in a paint spray booth. The additive composition may be added to the water before or after the water encounters the contaminant, or both, such as to the water entering or leaving the spray booth or sump systems.

The additive composition comprises a cyclodextrin, a cyclodextrin derivative, or combinations thereof. Addition of the additive composition to a recirculating water system for treating paint overspray particles in a paint spray booth results in a recirculating water system comprising a cyclodextrin, a cyclodextrin derivative, or combinations thereof. Accordingly, the present invention is also directed to a recirculating water system for treating oversprayed paints comprising water and the additive composition comprising a cyclodextrin, a cyclodextrin derivative, or combinations thereof.

As used herein, the term “cyclodextrin” or “cyclodextrins” (if more than one) refers to a family of cyclic oligosaccharides, consisting of a macrocyclic ring of glucose subunits joined by α-1,4 glycosidic bonds. The three most predominant species of cyclodextrins are α-cyclodextrin comprising 6 glucose subunits, β-cyclodextrin comprising 7 glucose subunits, and γ-cyclodextrin comprising 8 glucose subunits. The cyclodextrin of the present invention may comprise any cyclodextrin from the cyclodextrin family, including, but not limited to, α-cyclodextrin, β-cyclodextrin, and γ-cyclodextrin. Structures of α-cyclodextrin (α-CD), β-cyclodextrin (β-CD), and γ-cyclodextrin (γ-CD) are provided below.

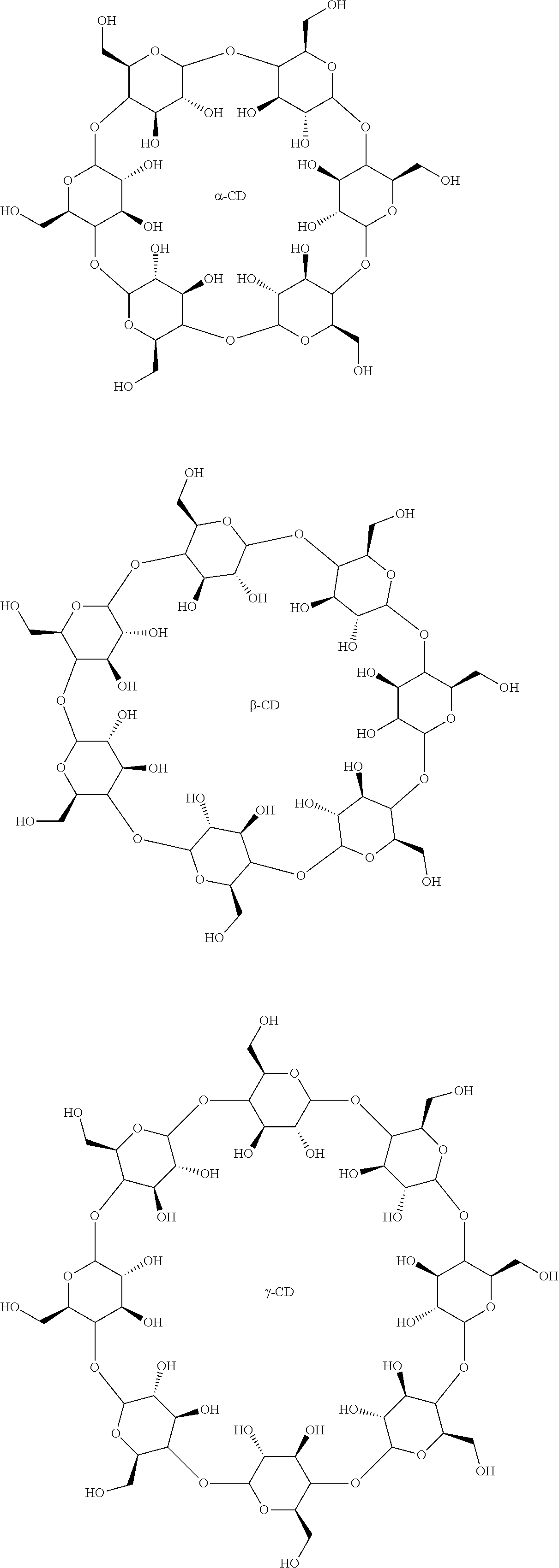

As used herein, the term “cyclodextrin derivative” refers to a compound, oligomer or polymer comprising at least one cyclodextrin moiety wherein at least one hydroxyl group of the cyclodextrin moiety has been chemically modified. For example, the cyclodextrin derivative may comprise a cyclodextrin that includes substitution of one or more of the hydroxyl groups of the cyclodextrin. This includes oligomeric or polymeric chain of cyclodextrin(s), or an oligomeric or polymeric chain of cyclodextrin(s) that include further substitution of individual cyclodextrin units. Any substitution of the cyclodextrin should essentially leave the cyclic structure intact, and the oligomeric or polymeric cyclodextrin derivative of the present invention will retain the cyclic structure of at least one of the cyclodextrin(s) unit present in the oligomer or polymer.

The cyclodextrin derivative according to the invention may be a derivative of any cyclodextrin of the cyclodextrin family, including, but not limited to, an α-, β- and/or γ-cyclodextrin derivative. Non-limiting examples of cyclodextrin derivatives include alkyl, hydroxyalkyl, thioalkyl, aminoalkyl, aminodialkyl, glycidylalykl, acid-alkyl, or acyl derivatives of cyclodextrin, including derivatives of α-, β- or γ-cyclodextrin (e.g., methyl, ethyl, hydroxyethyl, aminomethyl, aminodimethyl, aminoethyl, aminodiethyl, propyl, acetyl, succinyl, etc.). Non-limiting examples of cyclodextrin derivatives include cyclodextrin alkyl ethers such as the methyl ethers, ethyl ethers or propyl ethers of α-, β-, and γ-cyclodextrin. Non-limiting examples of hydroxyalkyl ethers include hydroxyethyl, hydroxypropyl, and dihydroxypropyl ethers of α-, β-, and γ-cyclodextrin. Non-limiting examples of carboxyalkyl ethers are carboxymethyl and carboxypropyl ethers of α-, β-, and γ-cyclodextrin and their alkali metal salts, such as the sodium carboxymethyl ethers. Other non-limiting examples of cyclodextrin include mixed ethers of α-, β-, and γ-cyclodextrin which contain at least two different groups of the alkyl ether, hydroxyalkyl ether or carboxyalkyl ether groups mentioned. Non-limiting examples of cyclodextrin esters are the acetic esters (acetylcyclodextrins) and propionic esters (propionylcyclodextrins) of α-, β-, and γ-cyclodextrin. Non-limiting examples of substituted cyclodextrin ethers or cyclodextrin esters are 2-aminoethyl- or 2-chloroacetyl-cyclodextrins. Further non-limiting examples of cyclodextrin derivatives include oligomeric or polymeric derivatives of cyclodextrin(s) (e.g., cross linked with epichlorohydrin or with polyisocyanate) and/or an alkyl, hydroxyalkyl, thioalkyl, aminoalkyl, aminodialkyl, glycidylalkyl, acid-alkyl, acyl derivative of these polymers.

The cyclodextrin derivative according to the invention may also comprise ionic groups. The ionic groups may comprise anionic groups, such as, for example, acid groups, or cationic groups, such as, for example, ammonium groups and/or sulfonium groups, among others. The ionic groups may optionally be neutralized with an oppositely charged ionic species to form a salt with the ionic group.

A combination of cyclodextrin(s) and/or cyclodextrin derivative(s) may also be used.

The additive composition for addition to a recirculating water system for treating paint overspray particles in a paint spray booth may comprise a non-liquid composition, a paste, or a liquid concentrate composition comprising a cyclodextrin, a cyclodextrin derivative, or combinations thereof. The type of composition may depend on a number of factors such as the concentration of cyclodextrin and/or cyclodextrin derivative, amount of water, and amounts of other additives present in the composition. For example, the type of composition may be determined as a continuum based upon the concentration of cyclodextrin and/or cyclodextrin derivative with a liquid solution comprising cyclodextrin and/or cyclodextrin derivative in any amount up to the solubility point of the cyclodextrin and/or cyclodextrin derivative, a liquid suspension comprising cyclodextrin and/or cyclodextrin derivative above its solubility point until the concentration of cyclodextrin and/or cyclodextrin derivative increases the viscosity of the composition into that of a paste composition, and higher levels of cyclodextrin and/or cyclodextrin derivative (e.g., greater than 80% by weight) with lower water levels being in the form of a non-liquid, powder composition.

The non-liquid composition may be in the form of a solid, such as, for example, a powder composition. The powder composition may comprise cyclodextrin, cyclodextrin derivative, or a combination thereof without other additional components. Alternatively, the powder additive composition may comprise other solid particles, including optional materials discussed below, such as co-flocculants, coagulants, etc.

The cyclodextrin and/or cyclodextrin derivative may be present in the powder in any suitable amount with the total amount dependent on any other optional components being present. For example, the cyclodextrin and/or cyclodextrin derivative may be present in the powder additive composition in an amount of at least 0.1% by weight, such as at least 50% by weight, such as at least 75% by weight, such as at least 90% by weight, such as at least 95% by weight, such as 100% by weight, based on the total weight of the powder additive composition. The cyclodextrin and/or cyclodextrin derivative may be present in the powder additive composition in an amount of no more than 100% by weight, such as no more than 99.9% by weight, such as no more than 95% by weight, such as no more than 90% by weight, such as no more than 75% by weight, such as no more than 50% by weight, based on the total weight of the powder additive composition. The cyclodextrin and/or cyclodextrin derivative may be present in the powder additive composition in an amount of 0.1% to 100% by weight, such as 0.1% to 99.9% by weight, such as 0.1% to 95% by weight, such as 0.1% to 90% by weight, such as 0.1% to 75% by weight, such as 0.1% to 50% by weight, such as 50% to 100% by weight, such as 50% to 99.9% by weight, such as 50% to 95% by weight, such as 50% to 90% by weight, such as 50% to 75% by weight, such as 75% to 100% by weight, such as 75% to 99.9% by weight, such as 75% to 95% by weight, such as 75% to 90% by weight, 90% to 100% by weight, such as 90% to 99.9% by weight, such as 95% to 100% by weight, such as 95% to 99.9% by weight, based on the total weight of the powder additive composition.

The additive compositions of the present invention in the form of a powder composition may be prepared, for example, by first combining the cyclodextrin and/or the cyclodextrin derivative and any of the optional additives described above by any suitable means that result in a homogenous mixture. The powders may be dry mixed in any suitable blender, such as, for example, Mirion blender, ribbon blender, ball mill, paddle blender, tumbler, hopper fluidization, diffusion, or any other tool used to mix powder.

The additive composition for addition to a recirculating water system for treating paint overspray particles in a paint spray booth may comprise a paste composition comprising a cyclodextrin, a cyclodextrin derivative, or combinations thereof, and a viscous carrier, water, and/or solvent. The paste additive composition may comprise solely of a cyclodextrin, a cyclodextrin derivative, or a combination thereof, and the viscous carrier. Alternatively, the paste additive composition may comprise other optional materials discussed below, such as co-flocculants, coagulants, etc.

The cyclodextrin and/or cyclodextrin derivative may be present in the paste in any suitable amount with the total amount dependent on any other optional components being present and the balance being water. For example, the cyclodextrin and/or cyclodextrin derivative may be present in the paste additive composition in an amount of at least 1% by weight, such as at least 15% by weight, such as at least 30% by weight, such as at least 50% by weight, such as at least 60% by weight, based on the total weight of the paste additive composition. The cyclodextrin and/or cyclodextrin derivative may be present in the paste additive composition in an amount of no more than 80% by weight, such as no more than 60% by weight, such as no more than 50% by weight, such as no more than 30% by weight, such as no more than 20% by weight, based on the total weight of the paste additive composition. The cyclodextrin and/or cyclodextrin derivative may be present in the paste additive composition in an amount of 1% to 80% by weight, such as 1% to 60% by weight, such as 1% to 50% by weight, such as 1% to 30% by weight, such as 1% to 20% by weight, 15% to 80% by weight, such as 15% to 60% by weight, such as 15% to 50% by weight, such as 15% to 30% by weight, such as 15% to 20% by weight, 30% to 80% by weight, such as 30% to 60% by weight, such as 30% to 50% by weight, 50% to 80% by weight, such as 50% to 60% by weight, 60% to 80% by weight, based on the total weight of the paste additive composition.

The additive composition for addition to a recirculating water system for treating paint overspray particles in a paint spray booth may comprise a liquid concentrate composition comprising a liquid carrier; and a cyclodextrin, a cyclodextrin derivative, or a combination thereof.

The liquid carrier may comprise an aqueous medium comprising water and optionally organic solvent and other solubilizing agents that may assist in solubilizing the cyclodextrin and/or the cyclodextrin derivative. As used herein, the term “aqueous medium” refers to a liquid medium comprising greater than 50% by weight water, based on the total weight of the aqueous medium. The aqueous medium may comprise water in an amount of at least 60% by weight, such as at least 70% by weight, such as at least 80% by weight, such as at least 90% by weight, based on the total weight of the aqueous medium. The aqueous medium may comprise water in an amount of 51% to 100% by weight, such as 60% to 100% by weight, such as 70% to 100% by weight, such as 80% to 100% by weight, such as 90% to 100% by weight, based on the total weight of the aqueous medium. For example, the additive composition may comprise a liquid carrier comprising a cyclodextrin, a cyclodextrin derivative, or combinations thereof, and an aqueous medium comprising water. Various solubilizing agents may optionally be added to render the cyclodextrin and/or the cyclodextrin derivative more readily soluble.

The liquid carrier may alternatively comprise a non-aqueous medium. As used herein, the term “non-aqueous medium” refers to a liquid medium comprising water in an amount of less than 50% by weight, based on the total weight of the non-aqueous medium. The non-aqueous medium may comprise water in an amount of less than 40% by weight, such as less than 30% by weight, such as less than 20% by weight, such as less than 10% by weight, such as less than 5% by weight, such as 0% by weight, based on the total weight of the non-aqueous medium. The non-aqueous medium may comprise water in an amount of 0% to 49% by weight, such as 0% to 40% by weight, such as 0% to 30% by weight, such as 0% to 20% by weight, such as 0% to 10% by weight, such as 0% to 5% by weight, based on the total weight of the aqueous medium.

The cyclodextrin and/or the cyclodextrin derivative may be present in the liquid concentrate composition in an amount of at least 0.001% by weight, such as at least 0.05% by weight, such as at least 0.10% by weight, such as at least 0.20% by weight, such as at least by weight, such as at least 0.30% by weight, such as at least 0.35% by weight, such as at least 0.40% by weight, based on the total weight of the liquid concentrate composition. The cyclodextrin and/or the cyclodextrin derivative may be present in the liquid concentrate composition in an amount of no more than 5% by weight, such as no more than 1% by weight, such as no more than 0.70% by weight, such as no more than 0.50% by weight, such as no more than 0.40% by weight, such as no more than 0.35%, such as no more than 0.3%, such as no more than 0.25% based on the total weight of the liquid concentrate composition. The cyclodextrin and/or the cyclodextrin derivative may be present in the liquid concentrate composition in an amount of 0.001% to 5% by weight, such as 0.001% to 1% by weight, such as 0.001% to 0.70% by weight, such as 0.001% to 0.50% by weight, such as 0.001% to 0.40% by weight, such as 0.001% to 0.35% by weight, such as 0.001% to 0.30% by weight, such as 0.05% to 0.25% by weight, such as 0.05% to 5% by weight, such as 0.05% to 1% by weight, such as 0.05% to 0.70% by weight, such as 0.05% to 0.50% by weight, such as 0.05% to 0.40% by weight, such as 0.05% to 0.35% by weight, such as 0.05% to 0.30% by weight, such as 0.05% to 0.25% by weight, such as 0.10% to 5% by weight, such as 0.10% to 1% by weight, such as 0.10% to 0.70% by weight, such as 0.10% to 0.10% by weight, such as 0.10% to 0.40% by weight, such as 0.10% to 0.35% by weight, such as 0.10% to 0.30% by weight, such as 0.10% to 0.25% by weight, such as 0.20% to 5% by weight, such as 0.20% to 1% by weight, such as 0.20% to 0.70% by weight, such as 0.20% to 0.50% by weight, such as 0.20% to 0.40% by weight, such as 0.20% to 0.35% by weight, such as 0.20% to 0.30% by weight, such as 0.20% to 0.25% by weight, such as 0.25% to 5% by weight, such as 0.25% to 1% by weight, such as 0.25% to 0.70% by weight, such as 0.25% to 0.50% by weight, such as 0.25% to 0.40% by weight, such as 0.25% to 0.35% by weight, such as 0.25% to 0.30% by weight, such as 0.30% to 5% by weight, such as 0.30% to 1% by weight, such as 0.30% to 0.70% by weight, such as 0.30% to 0.50% by weight, such as 0.30% to 0.40% by weight, such as 0.30% to 0.35% by weight, such as 0.35% to 5% by weight, such as 0.35% to 1% by weight, such as 0.35% to 0.70% by weight, such as 0.35% to 0.50% by weight, such as 0.35% to 0.40% by weight, such as 0.40% to 5% by weight, such as 0.40% to 1% by weight, such as 0.40% to 0.70% by weight, such as 0.40% to 0.50% by weight, based on the total weight of the liquid concentrate composition. It will be understood that the concentration of the cyclodextrin and/or cyclodextrin derivative may be increased by removal of the liquid carrier (e.g., water).

The liquid carrier may be present in the liquid concentrate composition in an amount of at least 95% by weight, such as at least 98% by weight, such as at least 99% by weight, such as at least 99.50% by weight, such as at least 99.70% by weight, based on the total weight of the liquid concentrate composition. The liquid carrier may be present in the liquid concentrate composition in an amount of no more than 99.95% by weight, such as no more than 99.90% by weight, such as no more than 99.80% by weight, such as no more than 99.75% by weight, such as no more than 99.70% by weight, such as no more than 99.65% by weight, such as no more than 99.40% by weight, based on the total weight of the liquid concentrate composition. The liquid carrier may be present in the liquid concentrate composition in an amount of 95% to 99.95% by weight, such as 95% to 99.90% by weight, such as 95% to 99.80% by weight, such as 95% to 99.75% by weight, such as 95% to 99.70% by weight, such as 95% to 99.65% by weight, such as 95% to 99.60% by weight, such as 98% to 99.95% by weight, such as 98% to 99.90% by weight, such as 98% to 99.80% by weight, such as 98% to 99.75% by weight, such as 98% to 99.70% by weight, such as 98% to 99.65% by weight, such as 98% to 99.60% by weight, such as 99% to 99.95% by weight, such as 99% to 99.90% by weight, such as 99% to 99.80% by weight, such as 99% to 99.75% by weight, such as 99% to 99.70% by weight, such as 99% to 99.65% by weight, such as 99% to 99.60% by weight, such as 99.50% to 99.95% by weight, such as 99.50% to 99.90% by weight, such as 99.50% to 99.80% by weight, such as 99.50% to 99.75% by weight, such as 99.50% to 99.70% by weight, such as 99.50% to 99.65% by weight, such as 99.50% to 99.60% by weight, such as 99.70% to 99.95% by weight, such as 99.70% to 99.90% by weight, such as 99.70% to 99.80% by weight, based on the total weight of the liquid concentrate composition.

When the liquid concentrate composition comprises only the liquid carrier and cyclodextrin or a cyclodextrin derivative, the amount of the components will add up to exactly 100% by weight, based on the total weight of the liquid concentrate.

Additionally, other optional compounds may be included in the additive composition and recirculating water system of the present invention to act as co-flocculants. Non-limiting examples of co-flocculants include acrylamide polymers, complex metal salts, non-cyclic polysaccharides, cellulose, and starches. The optional compounds may be present in an amount of at least 0.1% by weight, such as at least 25% by weight, such as at least 50% by weight, such as at least 75% by weight, based on the total solids weight of the additive composition. The optional compounds may be present in an amount of no more than 99% by weight, such as no more than 75% by weight, such as no more than 50% by weight, such as no more than 20% by weight, such as no more than 10% by weight, such as no more than 5% by weight, such as no more than 1% by weight, based on the total solids weight of the additive composition. The optional compounds may be present in an amount of 0.1% to 99% by weight, such as 0.1% to 75% by weight, such as 0.1% to 50% by weight, such as 0.1% to 20% by weight, such as 0.1% to 10% by weight, such as 0.1% to 5% by weight, such as 0.1% to 1% by weight, such as 25% to 99% by weight, such as 25% to 75% by weight, such as 25% to 50% by weight, such as 50% to 99% by weight, such as 50% to 75% by weight, such as 75% to 99% by weight, based on the total solids weight of the additive composition.

Non-limiting examples of useful acrylamide polymers include cationic acrylamide polymers. Examples of useful cation acrylamide polymers include polymers derived from dimethylaminoethylmethacrylate sulfuric acid salt, dimethylaminoethylmethacrylate methyl chloride quaternary ammonium salt, dimethylaminoethylmethacrylate methyl sulfate quaternary ammonium salt dimethylaminoethylacrylate methyl chloride quaternary ammonium salt, acrylamidopropyltrimethyl ammonium chloride, and mixtures thereof.

The additive composition may be substantially free, essentially free, or completely free of acrylamide polymers. For example, the additive composition may be substantially free, essentially free, or completely free of any or all of polymers derived from dimethylaminoethylmethacrylate sulfuric acid salt, dimethylaminoethylmethacrylate methyl chloride quaternary ammonium salt, dimethylaminoethylmethacrylate methyl sulfate quaternary ammonium salt dimethylaminoethylacrylate methyl chloride quaternary ammonium salt, and acrylamidopropyltrimethyl ammonium chloride. As used herein, the terms “substantially free” and “essentially free” with respect to acrylamide polymers in the additive composition refers to acrylamide polymers present, if at all, in amounts of less than 3% by weight or 1% by weight, respectively, based on based on the total weight of the additive composition.

The additive composition of the present invention may optionally further comprise a complex metal salt, which is capable of flocculating and/or coagulating the oversprayed paint. The complex metal salt may be any complex metal salt which is capable of coagulating and flocculating paint. Non-limiting examples of useful complex metal salts include aluminum chlorohydrate, aluminum sulfate (alum), zinc chloride, ferric chloride, calcium chloride, magnesium hydroxide, and mixtures thereof.

The additive composition may be substantially free, essentially free, or completely free of a complex metal salts described above. For example, the additive composition may be substantially free, essentially free, or completely free of any or all of aluminum chlorohydrate, aluminum sulfate (alum), zinc chloride, ferric chloride, calcium chloride, and magnesium hydroxide. As used herein, the terms “substantially free” and “essentially free” with respect to a complex metal salt in the additive composition refers to complex metal salt present, if at all, in amounts of less than 3% by weight or 1% by weight, respectively, based on based on the total weight of the additive composition.

The additive composition and recirculating water system of the present invention may optionally further include bentonite clay.

The additive composition may be substantially free, essentially free, or completely free of bentonite clay. As used herein, the terms “substantially free” and “essentially free” with respect to bentonite clay in the additive composition refers to bentonite clay present, if at all, in amounts of less than 3% by weight or 1% by weight, respectively, based on based on the total weight of the additive composition.

The additive composition and recirculating water system of the present invention may optionally further comprise a non-cyclic polysaccharide. As used herein, the term “non-cyclic polysaccharide” refers to a compound having monosaccharide units bound by glycosidic linkages in a linear or branched structure without forming any cyclic ring structures of monosaccharide units. The monosaccharide units themselves are cyclic. The non-cyclic polysaccharide may comprise various functional groups, such as, for example, hydroxyl groups, carboxylic acid groups, amino groups, and thiol groups, among others. The non-cyclic polysaccharide may further comprise ionic groups. The ionic groups may comprise anionic groups, such as, for example, acid groups (when dissociated), or cationic groups, such as, for example, ammonium groups and sulfonium groups, among others. The ionic groups may optionally be neutralized with an oppositely charged ionic species that forms a salt with the ionic group.

The non-cyclic polysaccharide may comprise a starch or starch derivative. Starch is a non-cyclic polysaccharide comprising a large number of glucose units joined together by glycosidic bonds. Starch is produced by all green plants as an energy store and is a major food source for humans. It consists of two types of molecules: the linear and helical amylose and the branched amylopectin. Depending on the plant, starch generally contains 20 to 25% by weight amylose and 75 to 80% by weight amylopectin. The starch derivative may comprise a cationic starch, and the cationic starch may have the following generalized structure:

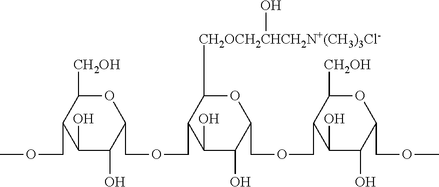

The non-cyclic polysaccharide may comprise cellulose or a cellulose derivative. Cellulose is a linear chain of several hundred to many thousands of β-1,4 glycosidic linked D-glucose units. The cellulose derivative may comprise cationic cellulose, such as cationic hydroxyethyl cellulose, cationic hydroxypropyl cellulose and/or cationic methylcellulose gum.

The non-cyclic polysaccharide may comprise guar gum or a guar gum derivative. guar gum is a non-cyclic polysaccharide comprising a linear chain of β-1,4-linked mannose residues to which galactose residues are 1,6-linked at every second mannose, forming short side-branches. The guar gum derivative may comprise cationic guar gum.

The non-cyclic polysaccharide may comprise inulin or an inulin derivative. Inulin is a linear polysaccharide comprising chain-terminating glucosyl moieties and a repetitive fructosyl moiety which are linked by β-1,2 bonds. The inulin derivative may comprise a cationic inulin.

The non-cyclic polysaccharide may comprise chitin. Chitin is a compound having the formula (C₈H₁₃NO₅)ₙ and the following generalized structure:

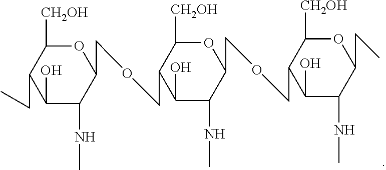

Chitin may be treated with a strong base to hydrolyze acetamido group(s), if present, to produce free amino groups. Such hydrolyzation forms the compound chitosan, a non-cyclic polysaccharide, which may be present in the additive composition and recirculating water system of the present invention. Chitosan has the following chemical structure:

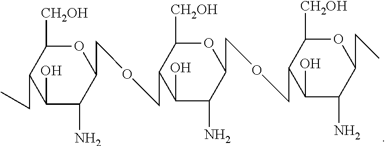

The additive composition may be substantially free, essentially free, or completely free of any one or all of the non-cyclic polysaccharides described above. For example, the additive composition may be substantially free, essentially free, or completely free of any one or all of starch and/or starch derivatives, cellulose and/or cellulose derivatives, guar gum and/or guar gum derivatives, inulin and/or inulin derivatives, and chitin and/or chitosan. As used herein, the terms “substantially free” and “essentially free” with respect to a non-cyclic polysaccharide in the additive composition refers to non-cyclic polysaccharides present, if at all, in amounts of less than 3% by weight or 1% by weight, respectively, based on based on the total weight of the additive composition.

Other optional co-flocculants include polydiallyldimethylammonium chloride (polyDADMAC) and epichlorohydrin-dimethylamine (Epi-DMA). The additive composition may be substantially free, essentially free, or completely free of polyDADMAC and/or Epi-DMA. As used herein, the terms “substantially free” and “essentially free” with respect to polyDADMAC and/or Epi-DMA in the additive composition refers to polyDADMAC and/or Epi-DMA present, if at all, in amounts of less than 3% by weight or 1% by weight, respectively, based on based on the total weight of the additive composition.

The additive composition may further comprise other optional components including, but not limited thereto, fillers, plasticizers, anti-oxidants, biocides, dispersing aids, flow control agents, surfactants, wetting agents, defoamers, pH stabilizers, colorants, dyes, suspending agents, anti-caking agents, or any combination thereof. The additive composition may alternatively be substantially free, essentially free, or completely free of any of these optional components. As used herein, the terms “substantially free” and “essentially free” with respect to any of these optional components in the additive composition refers to any of these optional components being present, if at all, in amounts of less than 3% by weight or 1% by weight, respectively, based on based on the total weight of the additive composition.

As mentioned above, the additive composition may be used for addition to recirculating water systems for treating paint overspray particles in a paint spray booth. The recirculating water system comprises an aqueous medium that is used to capture oversprayed paint particles generated during operation of the paint spray booth. The additive composition may be added to the aqueous medium of the recirculating water system that is recirculated through the paint spray booth as an initial detackifying additive to add an initial amount of the cyclodextrin, cyclodextrin derivative, or combinations thereof, to the recirculating water system. In addition, the additive composition may also optionally be added as a maintenance detackifying additive to the recirculating water system during operation of the paint spray booth to maintain an amount of the cyclodextrin, cyclodextrin derivative, or combinations thereof, in the recirculating water system, as will be discussed in more detail herein. Accordingly, the present invention is also directed to a recirculating water system comprising an aqueous medium, and a cyclodextrin, a cyclodextrin derivative, or combinations thereof.

When used in a recirculating water system, the additive composition may be added to the recirculating water system as an initial or maintenance detackifying additive in an amount in a sufficient quantity to efficiently treat the waste present in the water system. Accordingly, the amount of cyclodextrin and/or cyclodextrin derivative may depend upon the application for which it is being used and the amount of waste being treated by such use. For example, the additive composition may be added to the recirculating water system as an initial or maintenance dose in an amount such as to provide or maintain a cyclodextrin and/or cyclodextrin derivative content of at least 0.005% by volume, such as at least 0.01% by volume, such as at least 0.05% by volume, such as at least 0.1% by volume, based on the total volume of the aqueous medium of the recirculating water system. The additive composition may be added to the recirculating water system as an initial or maintenance detackifying additive in an amount such as to provide or maintain a cyclodextrin and/or cyclodextrin derivative content of no more than 10% by volume, such as no more than 5% by volume, such as no more than 1% by volume, such as no more than 0.5% by volume, based on the total volume of the aqueous medium of the recirculating water system. The additive composition may be added to the recirculating water system as an initial or maintenance detackifying additive in an amount such as to provide or maintain a cyclodextrin and/or cyclodextrin derivative content of 0.01% to 10% by volume, such as 0.05% to 5% by volume, such as 0.1% to 1% by volume, based on the total volume of the aqueous medium of the recirculating water system. The additive composition may be added to the recirculating water system as an initial or maintenance detackifying additive in an amount such as to provide or maintain a cyclodextrin and/or cyclodextrin derivative content of about 0.005% to about 0.15% by weight (about 50 to about 1500 parts per million (ppm)), such as 0.01% to about 0.15% by weight (about 100 to about 1500 parts per million (ppm)), such as 0.05% to 0.13% by weight (about 500 to 1300 ppm), such as 0.07% to 0.10% by weight (about 700 to 1000 ppm), based on the total weight of the aqueous medium of the recirculating water system.

The recirculating water system may be maintained at a pH between about 5-10, such as between about 7.5 and 9.0, such as between about 8 and 9, such as about 8.6. The pH of the recirculating water system may be adjusted as is known in the art.

The recirculating water system of the present invention may further comprise any of the optional ingredients described herein in addition to the aqueous medium and cyclodextrin and/or cyclodextrin derivative. Any of the optional ingredients may be added to the recirculating water system as an initial or maintenance additive in an amount such as to provide or maintain an additive content of about 0.01% to about 0.15% by weight (about 100 to about 1500 parts per million (ppm)), such as 0.05% to 0.13% by weight (about 500 to 1300 ppm), such as 0.07% to by weight (about 700 to 1000 ppm), based on the total weight of the aqueous medium of the recirculating water system.

The recirculating material system may optionally further comprise an acrylamide polymer, including any of the acrylamide polymers discussed above with respect to the additive composition.

Alternatively, the recirculating water system may be substantially free, essentially free, or completely free of acrylamide polymers. For example, the recirculating water system may be substantially free, essentially free, or completely free of any or all of polymers derived from dimethylaminoethylmethacrylate sulfuric acid salt, dimethylaminoethylmethacrylate methyl chloride quaternary ammonium salt, dimethylaminoethylmethacrylate methyl sulfate quaternary ammonium salt dimethylaminoethylacrylate methyl chloride quaternary ammonium salt, and acrylamidopropyltrimethyl ammonium chloride. As used herein, the terms “substantially free” and “essentially free” with respect to acrylamide polymers in the recirculating water system refers to acrylamide polymers present, if at all, in amounts of less than 100 ppm or 10 ppm, respectively, based on the total weight of the aqueous medium of the recirculating water system.

The recirculating material system may optionally further comprise a complex metal salt, including any of the complex metal salts discussed above with respect to the additive composition.

Alternatively, the recirculating water system may be substantially free, essentially free, or completely free of a complex metal salt as described above. For example, the recirculating water system may be substantially free, essentially free, or completely free of any or all of aluminum chlorohydrate, aluminum sulfate (alum), zinc chloride, ferric chloride, calcium chloride, and magnesium hydroxide. As used herein, the terms “substantially free” and “essentially free” with respect to a complex metal salt in the recirculating water system refers to complex metal salt present, if at all, in amounts of less than 100 ppm or 10 ppm, respectively, based on the total weight of the aqueous medium of the recirculating water system.

The recirculating material system may optionally further comprise bentonite clay.

Alternatively, the recirculating water system may be substantially free, essentially free, or completely free of bentonite clay. As used herein, the terms “substantially free” and “essentially free” with respect to bentonite clay in the recirculating water system refers to bentonite clay present, if at all, in amounts of less than 100 ppm or 10 ppm, respectively, based on the total weight of the aqueous medium of the recirculating water system.

The recirculating water system may optionally further comprise a non-cyclic polysaccharide, including any of the non-cyclic polysaccharides discussed above with respect to the additive composition.

Alternatively, the recirculating water system may be substantially free, essentially free, or completely free of any one or all of the non-cyclic polysaccharides described above. For example, the recirculating water system may be substantially free, essentially free, or completely free of any one or all of starch and/or starch derivatives, cellulose and/or cellulose derivatives, guar gum and/or guar gum derivatives, inulin and/or inulin derivatives, and chitin and/or chitosan. As used herein, the terms “substantially free” and “essentially free” with respect to a non-cyclic polysaccharide in the recirculating water system refers to non-cyclic polysaccharides present, if at all, in amounts of less than 100 ppm or 10 ppm, respectively, based on the total weight of the aqueous medium of the recirculating water system.

The present invention is also directed to a method of preparing a recirculating water system for treating paint overspray particles in a paint spray booth, the method comprising adding the additive composition of the present invention to the aqueous medium of the recirculating water system. The method may optionally further comprise adding a flocculant to the aqueous medium and/or adjusting the pH of the aqueous medium by addition of base (e.g., caustic) to a pH of about 8 to about 9, such as about 8.6, following addition of the additive composition.

The present invention is also directed to a method of maintaining a recirculating water system for treating paint overspray particles in a paint spray booth, wherein the recirculating water system comprises a cyclodextrin, a cyclodextrin derivative, or combinations thereof, and the method comprises adding the additive composition of the present invention to the aqueous medium of the recirculating water system.

The present invention is also directed to a method of treating oversprayed waterborne and/or solventborne paint particles in a paint spray booth that includes a recirculating water system, said method comprising contacting said oversprayed paint particles with an aqueous composition recirculating through the recirculating water system, wherein the aqueous composition comprises a cyclodextrin, a cyclodextrin derivative, or combinations thereof. The cyclodextrin and/or cyclodextrin derivative may be added to the aqueous composition of the recirculating water system using the additive composition described above.

In accordance with the method of the present invention, oversprayed paint particles in a paint spray booth are treated with a recirculating water system comprising a cyclodextrin, a cyclodextrin derivative, or combinations thereof, as described above. In particular, a paint spray booth including a recirculating water system is provided. The composition of the present invention as discussed above is added to the recirculating water system of the paint spray booth. The recirculating water system forms a continuous moving curtain which scrubs an air flow containing paint overspray in order to collect the paint overspray in the water curtain. Paint spray booths containing continuous curtains of water to scrub air flows containing paint overspray are known in the art, for example U.S. Pat. No. 4,980,030, which discloses typical paint spray booths. Where in the recirculating water system that the detackifying agent is added may depend upon the type of paint being used. For example, for water-based paint, contacting the water curtain results in a diluted paint and additional detackifying agent may be added as the water leaves the spray booth, whereas for solventborne paint, the paint tends to agglomerate and get sticky once the paint hits the water curtain, and the detackifying agent is typically added to the water going to the spray booth, i.e., the water is pretreated with the detackifying agent on its way to the spray booth. However, there can be multiple points at which the detackifying agent is added regardless of the paint type.

In operation, an object to be painted is placed within the paint spray booth and is painted using known spray techniques. The overspray paint is contacted with the continuous curtains of water comprising, including, containing, or the like a cyclodextrin and/or a cyclodextrin derivative which are pumped through the paint spray booth in known manner. Such contacting of the overspray paint with the water solution including a cyclodextrin, a cyclodextrin derivative, or combinations thereof causes the paint to flocculate and separate from the wash water, thereby forming a sludge layer on the water solution which is circulated through the paint spray booth. In addition, the composition of the present invention also detackifies the flocculated paint. The amount of the flocculated paint sludge in the water solution is monitored and removed periodically, through known methods. Additionally, the pH of the water solution is periodically monitored and readjusted, if necessary. Without intending to be bound by any theory, when the overspray comes into contact with water containing cyclodextrin and/or cyclodextrin derivative, the cyclodextrin and/or cyclodextrin derivative attracts the overspray paint particles and forms a complex to detackify and ultimately flocculate the paint particles. The contact with the cyclodextrin and/or cyclodextrin derivatives deactivates the paint particles and makes them not sticky, prevents them from contacting and contaminating surfaces in the paint spray booth, and allows for flocculation of the paint particles for ease of removal.

The effectiveness of the cyclodextrin and/or cyclodextrin derivative (detackifying agent) is also periodically monitored during operation of the paint spray booth. This may be accomplished by monitoring the tackiness of the paint sludge removed from the paint spray booth. Alternatively, the level of cyclodextrin and/or cyclodextrin derivative may be monitored to maintain a desired predetermined threshold level of the composition within the wash water. When the wash water fails to effectively detackify the oversprayed paint and/or when the level of the cyclodextrin and/or a cyclodextrin derivative drops below a desired predetermined threshold level, a maintenance dosage of cyclodextrin and/or cyclodextrin derivative, such as in the form of the additive composition of the present invention, may be added to the recirculating water, thereby maintaining the effectiveness of the paint spray booth.

The composition of the present invention is used in a similar manner when used in connection with solvent-based paint denaturant systems. An example of such a system is described in detail in U.S. Pat. No. 5,223,141, the disclosure of which is incorporated herein by reference thereto. Such solvent-based paint denaturant systems typically include as a wash water a dispersion of an organic solvent component in water. The cyclodextrin and/or cyclodextrin derivative, such as in the form of the additive composition of the present invention, is added to the dispersion. The water system may include substantial amounts of solvent, non-limiting examples of which include alkyl esters of polycarboxylic acids or mixtures of such esters, such as dimethyl adipate, dimethyl glutarate, dimethyl succinate and mixtures thereof; diisobutyl adipate, diisobutyl glutarate, diisobutyl succinate and mixtures thereof.

Examples of other organic solvents include polyol ethers including mono and diethers of glycols such as mono or dialkyl or mono or diaryl or mixed alkyl and aryl ethers of glycols such as ethylene glycol, diethylene glycol, dipropylene glycol and propanol and mixtures of glycol ethers. Examples of specific polyol ethers include ethylene glycol monobutyl ether, ethylene glycol monophenyl ether, diethylene glycol monobutyl ether, propylene glycol monomethyl ether, propylene glycol monophenyl ether, dipropylene glycol monomethyl ether, dimethylether of ethylene glycol and dimethylether of diethylene glycol. Other examples of organic solvents include furfural and isophorone.

The concentration of the organic solvent component in the aqueous dispersion may be from 2 to 49, such as from 15 to 25 percent by weight based on weight of organic solvent component and water.

The organic solvent component can be dispersed into the water by simply adding it to the recirculating water in a typical water wash spray booth. The cyclodextrin and/or cyclodextrin derivative may also added into the water in a similar manner. The pumping and circulation action associated with the spray booth ensures that the organic solvent component will be stably dispersed in the aqueous medium and ensures that the cyclodextrin and/or cyclodextrin derivative will remain properly mixed in the aqueous medium.

The paint overspray typically contains, for example, pigments, organic resins, water and/or organic solvent associated with industrial paints. The paints may be solvent-based, water-based or solvent-free, and may be acrylic-based paints, urethane-based paints, basecoat/clearcoat paints, and high solids or low solids paints which are used in the automotive, appliance and general industrial markets.

As described above, the overspray paint is contacted with water to form the wastewater. The method of contacting the overspray paint with water is not limited and may be by any suitable method. For example, the overspray paint may be contacted with continuous curtains of water that are pumped through the paint spray booth in known manner. Such contacting of the overspray paint with the dispersion including the organic solvent in water and the composition of the present invention collects the overspray paint in the dispersion. In other examples, the overspray paint may be contacted with aqueous liquid that is part of an electrostatic scrubber unit that is equipped with charged separating plates which are also wetted with the aqueous liquid. A non-limiting example of an electrostatic scrubber unit is described in U.S. Pat. No. 9,169,404, at col. 4, line 32 through col. 6, line 20, the cited portion of which is incorporated herein by reference.

The dispersion which contains the paint overspray is pumped through the system in known manner, such as to a sludge tank where the paint overspray can optionally be removed from the dispersion. The continuous circulation and pumping action keeps the dispersion agitated and stable. Optionally, at this point of the method, additional or a primary amount of the detackifying agent can be added.

In order to remove the paint sludge, the dispersion optionally may be transferred to a holding tank, where phase separation may be done into an organic phase and an aqueous phase. The organic phase which contains most if not all of the paint overspray is separated from the aqueous phase by skimming.

The organic phase may be further separated into an organic solvent portion and a portion which contains paint solids which comprise pigment and organic resin. Typical separating units would be a distillation column, a thin film evaporator, decanter, a centrifuge, or other mechanical separation methodologies. The organic solvent portion (which contains the organic solvent component initially used to formulate the dispersion as well as at least a portion of the organic solvent component associated with the paint) is recovered in either the distillate or centrifugate, and may be returned to the recirculating water system, where it can be readily dispersed. The paint solids as separated are reclaimed for further use or are disposed of.

As mentioned above, the additive composition comprising cyclodextrin and/or cyclodextrin derivatives may be used for treating contaminants from wastewater with contaminants other than paint. For example, the additive composition may be added to recirculating water systems to make a recirculating water system comprising cyclodextrin and/or cyclodextrin derivatives for removing other types of contaminants. The additive composition may also be combined with water prior to contaminants being added to the water. In addition, the additive composition could be combined with water that already includes contaminants. In any case, after allowing the cyclodextrin and/or cyclodextrin derivatives to flocculate the waste, the waste may be removed from the wastewater and disposed of. Non-limiting examples of contaminants include animal byproducts from slaughterhouses, human waste in wastewater treatment centers, as well as metals, salts, pesticides, or biological or microbial contaminants, among other materials such as those found in runoff water, municipal waste, and coal.

As used herein, the term “total weight of the recirculating water system” refers to the weight of the aqueous medium of the recirculating water system and any components dissolved or dispersed therein, including at least the cyclodextrin and/or the cyclodextrin derivative, and any of the optional components described above.

As used herein, unless otherwise defined, the term “completely free” with respect to a component means that the component is not present, i.e., 0.00% by weight, based on total composition weight.

For purposes of the detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “a” cyclodextrin, “a” cyclodextrin derivative, and “a” polysaccharide, a combination (i.e., a plurality) of these components can be used. In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

Whereas specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

Illustrating the invention are the following examples, which, however, are not to be considered as limiting the invention to their details. Unless otherwise indicated, all parts and percentages in the following examples, as well as throughout the specification, are by weight.

### EXAMPLES

The following detackifying compositions were produced to test the effectiveness and potency of cyclodextrin in treating contaminants from wastewater streams by combining the ingredients listed in the table below with stirring.

TABLE 1

Amount (% by weight)

| Ingredient | Ex. 1 | Ex. 2 | Ex. 3 | Ex. 4 |
|---|---|---|---|---|
| β-cyclodextrin¹ | 0.3 | — | 0.15 | — |
| β-cyclodextrin, amine | — | 0.3 | — | 0.15 |
| modified² | | | | |
| Cationic Guar³ | — | — | 0.15 | 0.15 |
| Water | 99.7 | 99.7 | 99.7 | 99.7 |

¹CAVAMAX 7, commercially available from Wacker Chemie AG
²CAVAMAX 7 TMA, commercially available from Wacker Chemie AG
³N-HANCE BF17, commercially available from Ashland

### Jar Testing of Water-Based Paints

Jar testing measures the effectiveness and potency of a detackifying composition for water-based paints. Jar testing was completed for the experimental detackifying compositions described above, and a comparative composition was made using 13.08% by weight of BC4205NP, a commercially available paint detackifier commercially available from PPG Industries. 100 mL of the water was added to a 120 mL jar and 0.2 mL of one of the water-based paints indicated in the table below was added with stirring by a magnetic stir bar. The water plus paint composition was intended to simulate a wastewater stream of a recirculating water system for treating oversprayed paint. After about 30 seconds, 1-2 drops (about 0.03 to mL) of a one of the example detackifying compositions of Examples 1-4 was added with stirring, and then the stirring was stopped. The jar was allowed to stand for 1-2 minutes and was observed for pin-floc, i.e., a breaking of the emulsion of into very fine clumps of paint particles dispersed in the water. This process was repeated until clear water was visible. The amount of detackifying composition required to break the emulsion was recorded for each example and is reported in the table below in the “mL Detack” column.

After the emulsion was observed to be broken by the detackifying agent, a hydrated flocculant composition was used to flocculate the paint particles. A hydrated flocculant composition was prepared by diluting flocculant ZETAG 8816, commercially available from BASF, in water to a 0.2% by weight concentration of active flocculant components. The composition was shaken vigorously and then allowed to sit for at least 1 hour and not longer than 24 hours in order to allow the active flocculant components to hydrate. 1-2 drops (about 0.03 to 0.06 mL) of the hydrated flocculant composition was added to the jar with stirring. The stirring was stopped, and the jar was allowed to stand for 1-2 minutes for observation of agglomeration of the paint particles. This process was repeated until the paint particles were sufficiently agglomerated, i.e., the paint particles agglomerated into chunks that settled to the bottom of the jar such that the water appeared clear aside from the agglomerates. The amount of flocculating composition used for each example is reported in the table below in the “mL Flocc” column.

In order to evaluate the compositions and effectiveness of the active components of the detackifying compositions, the compositions were compared by the paint-to-chemical weight ratio and, in order to normalize the comparison based upon the amount of active material included in each detackifying composition, by the detack index.

The paint-to-chemical ratio is the ratio of the volume of paint (mL) added to the water jar (i.e., 0.2 mL) relative to the total volume of detackifying composition (mL) added in order to achieve an acceptable detack level. The paint-to-chemical ratio can be expressed by the following formula:

Paint-to-chemical ratio=volume of paint (mL):volume of detackifying composition added (mL)

The detack index is used to normalize the amount of detackifying agent needed based upon the active component concentration of the compositions. For example, the comparative detackifying composition, BC4205NP, includes 13.08% of active chemical by weight, based on the total weight of the composition, while the experimental detackifying compositions of Examples 1-4 have only 0.30% of active chemical by weight, based on the total weight of the composition. Since the comparative composition includes 43 times more active chemical per unit volume, the detack index allows for a more effective comparison of the performance and potency of the active components in each composition since it accounts for the difference in concentration. The detack index was calculated by dividing the paint-to-chemical ratio by the weight percentage of active material present in the detackifying composition expressed as a ratio relative to 1, i.e., divided by 100. The formula can be expressed as:

Detack Index=(Paint-to-chemical ratio)/(% of active/100)

The higher the detack index, the more efficiently the detackifying agent detackifies paint, i.e., the detackifying agent can detackify more paint per weight of detackifying agent present. The detack index for each detackifying composition is included in the table below.

The results of these tests are presented below.

TABLE 2

| | % of | | Vol. of | | | Paint-to- | |
|---|---|---|---|---|---|---|---|
| Detack. | active (by | | Paint | mL | mL | chemical | Detack |
| Comp. | weight) | Paint | (mL) | Detack | Flocc | ratio | Index |
| BC4205NP⁴ | 13.08 | HWD18PR4⁵ | 0.2 | 0.06 | 0.33 | 1:0.3 | 25.5 |
| Ex. 2 | 0.30 | HWD18PR4⁵ | 0.2 | 1.05 | 0.33 | 1:5.25 | 63.5 |
| BC4205NP⁴ | 13.08 | OPP4656⁶ | 0.2 | 0.84 | 1.00 | 1:4.2 | 1.82 |
| Ex. 3 | 0.30 | OPP4656⁶ | 0.2 | 1.20 | 1.00 | 1:6 | 55.6 |
| Ex. 4 | 0.30 | OPP4656⁶ | 0.2 | 1.40 | 1.00 | 1:7 | 47.6 |

⁴Composition comprising water and 13.08% by weight of active paint detackifier commercially available as BC4205NP from PPG Industries.
⁵Water-based paint commercially available from PPG Industries.
⁶Water-based paint commercially available from PPG Industries.

The results of these tests demonstrate that the cyclodextrin and the cyclodextrin derivative used in Examples 2-4 have a higher capacity to detackify paint on a per weight of agent basis than the comparative commercially available detackifying composition. This is demonstrated by the higher detack index for the experimental compositions relative to the controls for each paint tested. Accordingly, less cyclodextrin and/or cyclodextrin derivative is needed on a per weight basis than the active detackifying agent of the comparative compositions.

In addition, the experimental detackifying compositions did not require any additional flocculating agent relative to the comparative detackifying agent.

### Recirculator Testing of Solventborne Paints

Recirculator testing was completed for the experimental detackifying compositions and the comparative composition described above.

The recirculator test was performed generally as described in U.S. Pat. No. 5,116,514, at col. 6, line 10 through col. 7, line 42, the cited portion of which is incorporated herein by reference. Specifically, the recirculator test includes a recirculator testing unit comprised of a recirculator vessel, a means for recirculating fluid, and a paint spray assembly. The recirculator vessel is open at its top and bottom to the recirculating means. The recirculating means is comprised of a vessel duct, a recirculator pump, an encircling waterway, and a funnel. The vessel duct interconnects the vessel with the recirculator pump, which pump is located below the vessel. The encircling waterway encircles the vessel about the vessel's entire side-circumference. The waterway is interconnected to the pump and provides a channel for the fluids passing through the duct and pump, upward to the funnel, where the fluid falls back into the vessel, forming a water curtain along the surface of the funnel. The paint spray assembly is comprised of a spray gun, disposed above the funnel, a pressure regulator, means for providing pressure (e.g., compressed air), a paint supply, and a first and second line, interconnecting respectively the spray gun to the paint supply and pressure regulator. The recirculator test is conducted with the recirculator testing unit as follows. 19,000 mL of tap water is charged to the recirculator vessel and then the pump is started. The pump draws the fluid (water and components of the additive composition) from the vessel through the duct and pumps it upward through the encircling waterway, where the fluid flows down the funnel, back into the vessel. An initial charge of one of the detackifying composition is then added, while such pumping is continued for the duration of the test. After the first five minutes of pumping the water and detackifying agent from the vessel up to the waterway, sodium hydroxide was added as needed to adjust the pH of the vessel contents to about 8.6, or at least to within the range of from a pH of 8 to a pH of 9, and the amount of sodium hydroxide (Liquid Caustic Diaphragm Grade) used for each example is indicated as the “LCD Usage” in the table below. When a stable pH reading at the desired pH is obtained (measured with a standard meter) the paint spray is commenced. The gun is an air atomized spray gun that is directed downward into the funnel, and the paint used was HCNCTX, a two-component (A and B component indicated as A/B in the table below) solventborne paint commercially available from PPG Industries. The paint spray assembly is preadjusted so as to spray paint into the funnel at a rate of from about 1.5 to about 2.0 mL of paint per minute, using an air pressure of from about 20 to about 30 psi. The spray gun is placed about 12 inches above the top rim of the funnel pointing downwards towards the funnel. The expected result of such paint spraying and fluid recirculating is the formation of a paint sludge which floats on the top of the vessel fluid. Such paint sludge is checked at intervals by the tester, using a water-wetted hand to squeeze a sample of the paint sludge between her or his fingers. The paint addition continued if the paint was killed, i.e., if the paint sludge was not tacky or sticky to the touch. Once the paint begins to stick, the detackifying agent is considered to be exhausted and the amount of paint added was recorded in mL of paint used.

In the recirculator testing, 1 mL of the detackifying composition was added to the recirculating water of the recirculator testing unit before any paint was sprayed and the pH was adjusted with caustic and the amount of caustic was recorded. The paint was then sprayed into the recirculator testing unit following the procedure described above. The paint addition was continued via spray until the detackifying agent was exhausted, i.e., the paint became tacky/sticky to the touch. The amount of paint needed to exhaust the detackifying agent was recorded. Another 1 mL of the detackifying composition was then added to the recirculating water and the pH of the composition was adjusted using caustic and the amount of caustic needed was recorded. The paint was again sprayed following the same procedure until the maintenance dosage of detackifying agent was exhausted. The amount of paint needed to exhaust the maintenance dosage of the detackifying agent was recorded. A third maintenance dosage of 1 mL of the detackifying composition was then added, and the pH was adjusted with caustic with the amount of caustic needed recorded. The paint was again sprayed following the same procedure until the maintenance dosage of detackifying agent was exhausted. The amount of paint needed to exhaust the maintenance dosage of the detackifying agent was recorded. The average amount of caustic needed to adjust the pH for each of the three dosages was calculated and is reported in the table below. Likewise, the average amount of paint sprayed before exhausting the detackifying agent was also calculated and is reported in the table below.

The paint to chemical ratio for the recirculator testing is reported in the table below, with the ratio being to average amount of paint used to exhaust the detackifying agent relative to the 1 mL additions of the detackifying composition. Lastly, in order to normalize the comparison of the detackifying compositions based upon the different concentrations of active component present in the control and experimental compositions, the detack index was also calculated following the same procedure discussed above.

TABLE 3

| | % of | | | | | | |
|---|---|---|---|---|---|---|---|
| | active | | Avg. | Avg. | | | |
| | in | | amount | amount | Avg. | | |
| | detack. | | of | of | mL | Paint-to- | |
| Detack. | comp. | | paint | detack | LCD | Chemical | Detack |
| Comp. | by wt. | Paint | (mL) | (mL) | Usage | Ratio | Index |
| BC4205NP⁴ | 13.08 | HCNCTXA/B | 14.6 | 1 | 0.23 | 14.6:1 | 112 |
| Ex. 1 | 0.30 | HCNCTXA/B | 7 | 1 | 0.11 | 7:1 | 2,333 |
| Ex. 2 | 0.30 | HCNCTXA/B | 15.3 | 1 | 0.13 | 15.3:1 | 5,100 |

⁴Composition comprising water and 13.08% by weight of paint detackifier commercially available as BC4205NP from PPG Industries.

The results of these tests demonstrate that both the cyclodextrin and the cyclodextrin derivative used in Examples 1 and 2 have a higher capacity to detackify the solventborne paint on a per weight of detackifying agent than the comparative commercially available detackifying composition. This is demonstrated by the significantly higher detack index for the experimental compositions relative to the control for the paint tested. Accordingly, less cyclodextrin and/or cyclodextrin derivative is needed on a per weight basis than the active detackifying agent of the comparative composition.

In addition, the experimental detackifying composition of Examples 1 and 2 also required less caustic to neutralize the recirculating water following addition of the detackifying composition. This is advantageous because using less caustic will reduce the cost of utilizing the experimental detackifying compositions relative to the comparative commercially available composition.

Furthermore, cyclodextrin and the cyclodextrin derivative proved to be effective against both water-based and solventborne paints, an important property in paint processing areas where multiple types of paints are being used with the same water recirculation system and pit.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1-11. (canceled)

12. A method of treating oversprayed paint particles in a paint spray booth including a recirculating water system for treating oversprayed paint comprising an aqueous medium comprising a cyclodextrin, a cyclodextrin derivative, or a combination thereof, the method comprising:
contacting the oversprayed paint particles with the aqueous medium recirculating through the recirculating water system.

13. The method of claim 12, wherein the cyclodextrin comprises α-cyclodextrin, β-cyclodextrin, γ-cyclodextrin, or combinations thereof.

14. The method of claim 12, wherein the cyclodextrin derivative comprises an oligomeric or polymeric derivative.

15. The method of claim 12, wherein the cyclodextrin derivative comprises a cationic cyclodextrin.

16. The method of claim 12, wherein the cyclodextrin derivative comprises an amino-functional cyclodextrin.

17. The method of claim 12, wherein the cyclodextrin derivative comprises an amino-functional, cationic cyclodextrin derivative.

18. The method of claim 12, wherein the aqueous medium further comprises a polysaccharide.

19. The method of claim 18, wherein the polysaccharide comprises a cationic polysaccharide.

20. The method of claim 19, wherein the cationic polysaccharide comprises cationic inulin.

21. The method of claim 19, wherein the cationic polysaccharide comprises cationic cellulose.

22. (canceled)

23. The method of claim 12, wherein the aqueous medium has a cyclodextrin and/or cyclodextrin derivative content of 0.005% to 0.15% by weight, based on the total weight of the aqueous medium of the recirculating water system.

24. The method of claim 12, wherein the aqueous medium further comprises at least one co-flocculant comprising acrylamide polymers, complex metal salts, non-cyclic polysaccharides, cellulose, and/or starches, and the co-flocculant is present in a concentration of 0.01% to 0.15% by weight, based on the total weight of the aqueous medium of the recirculating water system.

25. The method of claim 12, wherein the aqueous medium is substantially free, essentially free, or completely free of any one or all of acrylamide polymers, complex metal salts, non-cyclic polysaccharides, cellulose, and/or starches.

26. The method of claim 12, wherein the aqueous medium further comprises bentonite clay.

27-31. (canceled)

32. A method for preparing a recirculating water system for treating oversprayed paint in a paint spray booth, the method comprising:
adding an additive composition comprising a cyclodextrin, a cyclodextrin derivative, or a combination thereof to the recirculating water system.

33. A method for maintaining a recirculating water system for treating oversprayed paint in a paint spray booth, the method comprising:
adding an additive composition comprising a cyclodextrin, a cyclodextrin derivative, or a combination thereof to the recirculating water system.

34-62. (canceled)
